(19) United States
(12) Patent Application Publication
(10) Pub. No.: US 2021/0048133 A1
(43) Pub. Date: Feb. 18, 2021

(54) PLUMBING PIPE SYSTEM AND PLUMBING PIPE SLEEVE

(71) Applicant: STEALTH PIPE, LLC, Skippack, PA (US)

(72) Inventor: Joseph Davis, Collegeville, PA (US)

(73) Assignee: STEALTH PIPE, LLC, Skippack, PA (US)

(21) Appl. No.: 16/993,639

(22) Filed: Aug. 14, 2020

Related U.S. Application Data
(60) Provisional application No. 62/887,707, filed on Aug. 16, 2019.

(51) Int. Cl. F16L 55/033; G10K 11/162

(52) U.S. Cl. CPC F16L 55/033; G10K 11/162

(57) ABSTRACT

A noise reducing pipe system may include a pipe having a first end and a second end. The system may also include a pipe coating connected to the pipe and extending continuously around the circumference of the pipe. The pipe coating may also extend substantially the length of the pipe. The first end and the second end of the pipe have an exposed portion that does not have the pipe coating connected thereto. The exposed portion on each of the first end and the second end is defined as having a length equal to one half an inside diameter of the pipe. There is no space between the pipe coating and the pipe so that substantially all portions of an outer wall of the pipe are in contact with the pipe coating.

### RELATED APPLICATIONS

This application claims priority under 35 U.S.C. § 119(e) of U.S. Provisional Patent Application Ser. No. 62/887,707 (Attorney Docket No. 4494.00001) filed on Aug. 16, 2019 and titled PLUMBING PIPE SYSTEM AND PLUMBING PIPE SLEEVE. The content of this application is incorporated herein by reference.

### FIELD OF THE INVENTION

The present invention relates to plumbing in general and, more specifically, to a pipe system that may be used in plumbing applications to provide noise reduction qualities. The present invention also relates to a pipe sleeve to retrofit existing plumbing pipes to provide noise reduction qualities.

### BACKGROUND OF THE INVENTION

In the construction of residential and commercial structures, plumbing systems can be one of the most noise-related utilities in the structure. This is especially true for plumbing systems carrying waste water. Another example of a major source of noise related to plumbing is flushing of toilets, as well as draining of washing machines. Commercial structures, hospitals, high rise hotels, condominiums, and any other structure with modern plumbing likely suffers from noise caused by fluid traveling through piping.

Cast iron pipe has been used to attempt to solve this problem. Fluid flowing through cast iron pipes tends to make less noise. The use of cast iron pipe, however, is quite expensive. Further, cast iron pipe can prove difficult to cut, which leads to additional cost during installation. Yet another disadvantage of cast iron pipe is additional labor time required to fasten a coupler device on each end of the pipe or fitting, as well as additional labor time associated with installation due to the weight of cast iron pipes. For example, a commonly used section of ten-foot cast iron pipe is too heavy for one person to install alone. Cast iron also suffers from deterioration and cracking over time.

Other products have been used in an attempt to decrease the sound that fluid makes when traveling through a pipe. For example, products have been provided in a tape format, requiring an installer to manual wrap and the product to an already installed pipe. This process is labor intensive, especially when trying to fully wrap fittings, and is not always possible to accomplish in the field. Further, due to the limited available space on an interior or exterior framed wall, the process may be even more difficult and more labor intensive, leading to added expense.

There have been other attempts to reduce noise within a pipe. For example, U.S. Pat. No. 3,877,491 to Thastrup discloses an insulated pipe. The insulating layer in the Thastrup '491 patent specifically notes that portions of pipe that are to be joined together do not include any of the insulating material. This will cause noise to be a problem for a pipe system adjacent to joints.

U.S. Pat. No. 4,309,007 to Logsdon discloses a sound insulating support for plumbing pipes. More specifically, the Logsdon '007 patent discloses an elaborate sleeve that includes spaces so as not to completely cover the pipe and is only designed to connect to the pipe when the pipe passes through a structural item. U.S. Pat. No. 3,559,660 to Rollins discloses a configuration of pipe insulation that is also complex, and that includes spaces which will allow pipe noise to carry. U.S. Pat. No. 7,913,718 to Cornwall discloses a noise reduction system for a drain waste vent, and includes spacers positioned between the pipe and the covering material to provide space therebetween.

Based on the above referenced deficiencies, a noise reducing plumbing pipe system is needed to reduce the amount of pipe noise that is encountered in plumbing applications.

### SUMMARY

With the above in mind, the present invention is directed to a noise reducing pipe system. The noise reducing pipe system may be referred to herein as a pipe system. The pipe system may include a pipe having a first end and a second end. The pipe system may also include a pipe coating connected to the pipe and extending continuously around the circumference of the pipe and extending substantially the length of the pipe. The first end and the second end of the pipe may have an exposed portion that does not have the pipe coating connected thereto. The exposed portion on each of the first end and the second end may be defined as having a length equal to one half an inside diameter of the pipe. The pipe coating is affixed to the pipe in a manner so that substantially all portions of an outer wall of the pipe are in contact with the pipe coating, and there is no space therebetween.

The pipe coating may be manufactured using crosshead extrusion and may be a material that is at least one of mass loaded vinyl material and fire rated mass loaded vinyl material. The pipe coating may also have a thickness ranging between 1/16 inch thick and ¼ inch thick. Further, the pipe may have an inside diameter ranging between 1 inch to 18 inches. The pipe may, for example, be PVC and/or ABS pipe.

The thickness of the pipe coating, in some embodiments, may be 25% as thick as a wall of the pipe. In other embodiments, the thickness of the pipe coating may be between 50% and 75% as thick as a wall of the pipe. Still in other embodiments, the thickness of the pipe coating may be substantially similar to the thickness of the wall of the pipe. The noise reducing pipe system may also include an adhesive positioned between the pipe coating and the pipe.

The noise reducing pipe system may further include a pipe fitting adapted to be connected either or both of the first and second ends of the pipe. The pipe fitting may be either an ABS and/or a PVC pipe fitting. The pipe system according to the present invention may also include a respective pipe fitting coating that is connected to the respective pipe fitting. The pipe fitting coating may extend continuously around the circumference of the pipe fitting and may extend substantially the length of the pipe fitting. Between ¼ inch and 3 inches of an end of the pipe fitting may be left exposed when the pipe fitting coating is affixed to the pipe fitting.

In some embodiments of the noise reducing pipe system, the pipe coating is a pipe sleeve having an internal diameter larger than a diameter of an outer surface of the pipe. The pipe sleeve may have a longitudinally extending opening that extends the entire length thereof. The pipe sleeve may engage the pipe to surround substantially the entire circumference of the pipe. When connected to the pipe, the outer circumference of the pipe is in continuous contact with the inner circumference of the pipe sleeve.

### BRIEF DESCRIPTION OF THE DRAWINGS

FIG. 1 is a front view of a pipe system having noise reduction qualities according to the present invention.

FIG. 2 is a perspective view of the pipe system illustrated in FIG. 1 showing an end portion thereof.

FIG. 3 is a front perspective view of a pipe sleeve according to the present invention being positioned to encase a pipe.

FIG. 3A is a front perspective view of the pipe sleeve illustrated in FIG. 3 spaced apart from a pipe.

FIG. 4 is another embodiment of the pipe system according to the present invention having noise reduction qualities in a pipe fitting.

FIG. 5 is another embodiment of the pipe sleeve being connected to a pipe fitting according to the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text provides a pipe system 10 used for plumbing purposes that has noise reduction and/or noise dampening qualities, Various types of pipes 12 can be used to achieve the features, benefits and advantages of the present invention. For example, ABS pipe (acrylonitrile butadiene styrene) may be used in plumbing applications that are suitable for installation of the present invention. ABS pipe is manufactured with ABS resin that is melted and fed through an extrusion machine. Also, for example, PVC pipe (polyvinyl chloride) may be used in plumbing applications that are also suitable for installation of the present invention. PVC pipe is manufactured with PVC resin and plasticizers that are melted and fed through an extrusion machine.

Those skilled in the art will appreciate that the extrusion process is a process of forming symmetrical piping. This can be done using a powder, a resin, or pellets of various types of material that can be melted and run through an extrusion device. Those skilled in the art will also appreciate that an extrusion process can be used to form other shapes besides piping. Another process that can be used to manufacture the pipe 12 of the pipe system 10 according to the present invention is crosshead extrusion. A crosshead extrusion process includes coating one product over another product with the use of powder, resin or pellets melted and run through a crosshead extrusion machine.

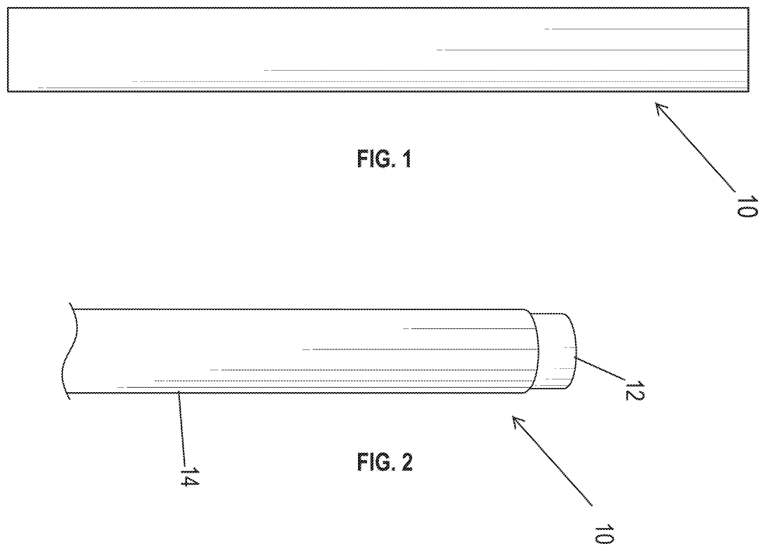

As perhaps best illustrated in FIGS. 1 and 2, the pipe system 10 according to the present invention includes a pipe 12 having an outer coating 14 (also referred to herein as a pipe coating 14) connected thereto. The pipe system 10 illustrated in FIG. 1 shows the pipe (not visible in FIG. 1) having the pipe coating 14 connected thereto. Those skilled in the art will appreciate that crosshead extrusion is just one of several processes that can be used to connect the pipe coating 14 to the pipe 12 to form the pipe system 10 according to embodiments of the present invention.

The pipe coating 14 may, for example, be made of any sort of material that includes noise dampening properties. For example, the preferred embodiment of the pipe system 10 according to the present invention may include mass loaded vinyl material. Mass loaded vinyl material is manufactured using pelletized polymer that is melted and fed through an extrusion machine. Components of mass loaded vinyl material may include polyvinyl chloride, calcium carbonate, or barium sulfate. Another type of material that may be used for the pipe coating 14 may be fire rated mass loaded vinyl. Fire rated mass loaded vinyl may include materials similar to mass loaded vinyl and may have a foil face to enhance fire rating.

The pipe coating 14 may be provided by 1/16″, ⅛″ or ¼″ thickness white or black mass loaded vinyl material, or white or black fire rated mass loaded vinyl material. As indicated above, the pipe coating 14 may be coated on (or connected to) an outer surface portion of any pipe. The present invention contemplates that the pipe coating 14 may be used to coat pipes 12 that have diameters ranging from 1″ to 18″. Those skilled in the art will appreciate that these diameters are inside diameter. The pipe coating 14 of the pipe system 10 according to the present invention may also be used to coat PVC or ABS pipes and fittings 18 that are commonly used in the plumbing and mechanical industries.

The present invention contemplates that the pipe coating 14 may be applied either during or after the manufacturing process of the PVC or ABS piping and/or fitting. As indicated above, one of the several ways that the pipe coating 14 can be applied to the pipe 12 and/or pipe fitting 14 is to use a crosshead extrusion coating process to create a sound deadening effect. Those skilled in the art will appreciate that the pipe coating 14 may be connected to the pipe 12 using an adhesive. For example, adhesive material may be applied to an outer circumference of the pipe 12 and allow for the pipe coating 14 to be applied thereon. When the pipe coating 14 is connected to the pipe 12, in the preferred embodiment, there is very little to no space between the pipe 12 and the pipe coating 14. One of the pipe coating 14 is connected to the pipe 12 using the adhesive material, the adhesive may be applied as a layer that covers substantially the entire circumference of the pipe or may be applied on various portions on the outer circumference of the pipe. Using the adhesive advantageously allows for a secure fit between the pipe 12 and the pipe coating 14. The fit between the pipe 12 and the pipe coating 14, and the elimination of space between the pipe 12 and the pipe coating 14 advantageously decreases the amount of noise in the pipe 12 that is caused by water, or another fluid, traveling therethrough. The present invention contemplates, however, that the pipe coating 14 may be applied to the pipe 12 without an adhesive so that the pipe coating inner portion is in contact with the pipe outer portion.

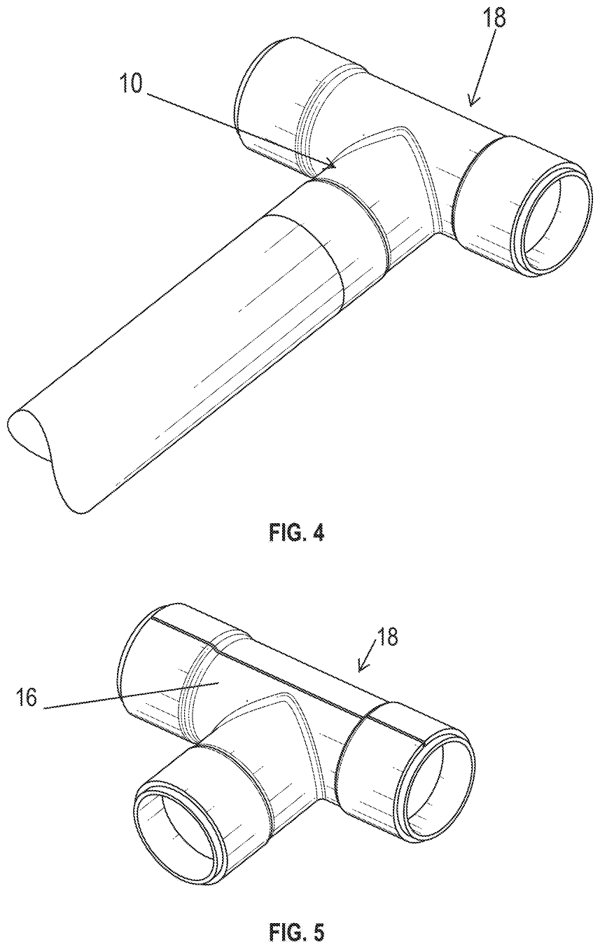

Those skilled in the art will appreciate that PVC and ABS fittings are typically manufactured using an injection molding process. To apply the pipe coating 14 to the PVC or ABS fitting 12, a mass loaded vinyl material, which may, for example, exist in sheet form, may be applied to the fitting 12 after the fitting is formed. The typical fitting will have a 1/16″, ⅛″ or ¼″ thickness. The mass loaded vinyl material which may be fire rated, preferably has a 1/16″, ⅛″, or ¼″ thickness and may be sheathed or coated to the outer layer of fittings 12 to create fittings in accordance with the pipe system 10 according to the present invention which will have noise dampening and/or noise reducing features. The pipe fitting 12 discussed above is illustrated in FIG. 4. More specifically, FIG. 4 illustrates an embodiment of the pipe system 10 according to the present invention in which the pipe fitting 18 is configured in a T-configuration and includes the pipe coating 14 connected thereto. Those skilled in the art will appreciate that similar to the application of pipe coating 14 to the fitting 12, the pipe coating in sheet format may be applied to the pipe 12 after the pipe is manufactured as well. Further, it will be appreciated by the skilled artisan that the coating 14 may be applied to the fitting during manufacturing of the fitting as well.

The outer coating 14 may have a thickness of 1/16″, ⅛ or ¼″. Further, the outer coating 14 may have an inside diameter ranging from 1″ to 18⅛%. Those skilled in the art will appreciate that the outer coating 14 may be provided in a premade sleeve. Such an embodiment will be discussed in greater detail below. A premade sleeve that is provided for the outer coating 14 may be manufactured using an extrusion process, as referenced above.

In the preferred embodiment of the present invention, a thickness of ⅛″ for the outer coating 14 is preferable for PVC pipe due to weight and ease of installation. Further, using a thickness of ⅛″ white mass loaded vinyl or ⅛″ white fire rated mass loaded vinyl for the outer coating 14 advantageously allows for an installer and/or an inspector to visually inspect primer that is typically used at fitting joints. Those skilled in the art will appreciate that purple primer is required by code in most areas before the process of installing fitting joints is carried out. Installing fitting joints may, for example, be carried out using a glue process to create a solvent weld joint.

When using the present invention to provide sound dampening or sound reducing features to an ABS pipe, it is preferable to use an outer coating 14 that comprises black mass loaded vinyl. A thickness of ⅛″ black mass loaded vinyl or ⅛″ black fire rated mass loaded vinyl is preferable due to weight and ease of installation. Those skilled in the art will appreciate that ABS pipe does not require the use of a cleaner on the pipe or fittings.

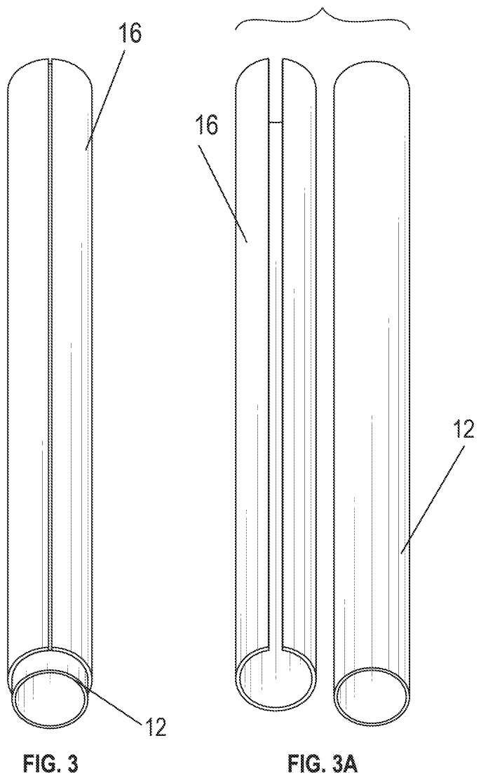

As illustrated in FIG. 3 and FIG. 3A, the pipe system 10 according to embodiments of the present invention may also include a pipe sleeve 16 that may be adapted to be positioned around a pipe 12. The pipe sleeve 16 may have an internal diameter that is slightly larger than an external diameter of a pipe 12 that it is to be positioned onto, i.e., the pipe 12 that is to be contained by the pipe sleeve 16. FIG. 3 illustrates the pipe sleeve 16 being positioned over the pipe 12, and FIG. 3A illustrates the pipe sleeve 16 separated and spaced apart from the pipe 12. The pipe sleeve 16 may illustratively include a slit or an opening that extends longitudinally substantially the entire length of the pipe sleeve. The longitudinally extending slit or opening allows the pipe sleeve 16 to be positioned to fit over a pipe 12 that is existing in a structure. More specifically, it allows for a pipe 12 to be retrofitted with the pipe sleeve 16 according to the present invention to provide the pipe with noise dampening or noise reducing properties. When manufacturing the pipe sleeve 16 according to the present invention, the pipe sleeve 16 may be manufacturing using an extrusion process. After the pipe sleeve 16 is manufactured, the pipe sleeve may be longitudinally cut the distance of the pipe.

As further illustrated in FIG. 5, the pipe sleeve 16 according to the present invention may also be adapted in a shape having a T-configuration to accommodate pipe fittings 18. The pipe sleeve 16 illustrated in FIG. 5 may be used to retrofit a pipe fitting 18. The pipe fitting 18 illustrated in FIG. 5 has a T-configuration, but those skilled in the art will appreciate that the pipe fitting 18 may have any shape, and that the pipe sleeve 16 used to connect to the pipe fitting may be provided with a similar shape so that such an existing pipe can be retrofitted to include the noise dampening or noise reducing features offered by the present invention.

Another advantage of the pipe system 10 and the pipe sleeve 16 according to embodiments of the present invention is that is that installation thereof provides additional strengthening qualities to a PVC or ABS pipe due to the additional sound deadening layer coated on the outermost layer of the piping. In the embodiment of the present invention using the pipe sleeve 16, the pipe sleeve may be installed without permanently attaching it to the pipe 12. This is advantageous in that it allows for pipe 12 to be cut to a desired length and allows for removing a portion of the pipe sleeve 16 as necessary. This can be readily accomplished using a razor knife or a similar tool, for example, to allow space for solvent weld fittings, snap fittings or fittings that require a coupling device. This is best illustrated in FIG. 2 and FIG. 3. For example, as can be seen in the pipe system 10 embodiment of the invention illustrated in FIG. 2, when the pipe 12 is manufactured with the outer coating 14 connected thereto, an end portion of the pipe is left exposed to as to allow for the end portion of the pipe to be readily connected to a fitting 18. The end portion of the pipe that is left exposed may, for example, be between ¼″ to 3″ in length, but those skilled in the art will appreciate that any amount of pipe can be left exposed as needed for various uses. The end portion of the pipe 12 to be left exposed may also be defined as having a length that is ½ the diameter of the pipe. Therefore, for example, if the pipe has a diameter of 3 inches, it would be preferred for the end portion to be left exposed to be 1.5 inches in length.

This will advantageously allow for the end of the pipe 12 to be readily connected to a fitting 18. Those skilled in the art will appreciate that the pipe system 10 may be manufactured so that the outer coating 14 is connected to the pipe 12 in a manner that leaves any length of pipe exposed at the end portion thereof as may be necessary depending on the type of fitting that is to be used. Those skilled in the art will also appreciate that when using the pipe system 10 according to embodiments of the present invention, it is contemplated, as referenced above, that the outer coating 14 may be readily removable from the pipe 12 by an installer to allow any desired length of pipe 12 to be exposed at an end portion thereof for purposes of fitting the pipe system to the fitting, which is illustrated in FIGS. 4 and 5. As will be discussed in greater detail below, portions of the pipe fitting may also be left exposed. This will allow for the pipe fitting to be connected to the pipe, so that the exposed portions of the pipe and the pipe fitting abut one another, and when connected, the outer coating 14 of the pipe will meet the outer coating of the pipe fitting (as described in greater detail below). When the outer coating of the pipe and the outer coating of the pipe fitting meet, the pipe and pipe fitting combination will have an outer coating that is substantially continuous to advantageously decrease the amount of noise that is caused when water, or another fluid, travels through the pipe.

The present invention provides a fast and simplified installation process in the field when used in connection with PVC and ABS pipes 12 and fittings 18. For example, sections of the pipe system 10 may be readily cut and removed to repair possible damage that may have occurred to the pipe system 10 during or after construction. To be specific, another advantage of the pipe system 10 according to the present invention is that it does not prevent or impede cutting and/or removal thereof when necessary. Further, in sections of piping that must be replaced, the pipe sleeve 16 of the present invention may be used if a pipe 12 having the outer coating 14 connected thereto is not available. In such a scenario, an installer can use traditional fittings 18 and a pipe 12 to make a repair and connect the pipe sleeve 16 thereto to provide the noise reducing and/or noise dampening features of the present invention.

The pipe system 10 and the pipe sleeve 16 according to the present invention also advantageously reduces vibrations in pipes that are attached to or installed through construction materials. This is most commonly encountered when pipes are passed through wood, for example, or other building materials used to form walls. In such cases, vibration and creaking noises commonly occur. Accordingly, use of the pipe system 10 according to the present invention can advantageously reduce noise associated with vibration and creaking noises in such situations. This is also a common occurrence when pipes are attached to strapping or hangers, and such problems are resolved using the pipe system 10 and/or the pipe sleeve 16 according to embodiments of the present invention.

Use of the pipe system 10 according to the present invention is also advantageous as it weighs significantly less than other attempted solutions to noise encountered in plumbing systems. For example, a 20 foot long length of the pipe system 10 according to the present invention, i.e., a pipe 12 (for example a PVC pipe) having the outer coating 14 connected thereto, wherein the outer coating is a ⅛″ thickness outer coating (as detailed above) weighs less than a 10 foot long length of cast iron pipe of the same diameter. This advantageously for faster and more economical installation.

Testing has indicated that use of the pipe system 10 according to the present invention provides many advantages to use of cast iron pipe. Testing was conducted using two gallons of water resting in a 3″×4′ horizontal PVC pipe. Water was then released from a 3″ full port ball valve. Water passed down to a 3″ diameter and 5′ vertical stack pipe. A decibel meter was affixed to the side of each vertical pipe at the midpoint section during testing, The decibel meter used for testing was general model #DSM8930. Three tests were performed on each style of piping. The piping that was used in the testing was Schedule 40 PVC piping, cellular core PVC piping and cast iron piping, all without the sound deadening coating. The average decibel reading for the Schedule 40 PVC piping was 95. The average decibel reading for the cellular core PVC piping was 96. The average decibel reading for cast iron piping was 84.

Thereafter, the pipe system 10 according to the present invention was tested. The pipe system 10 that was tested included Schedule 40 PVC pipe having ⅛″ thickness black mass loaded vinyl sleeved thereover. When the pipe system 10 having the pipe 12 with a pipe sleeve 16 connected thereto was tested in the same fashion as outlined above, the average decibel reading of 85, which was similar to the cast iron pipe readings.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the description of the invention. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced items.

That which is claimed:

1. A noise reducing pipe system comprising:
a pipe having a first end and a second end;
a pipe coating connected to the pipe and extending continuously around the circumference of the pipe and extending substantially the length of the pipe;
wherein the first end and the second end of the pipe have an exposed portion that does not have the pipe coating connected thereto;
wherein the exposed portion on each of the first end and the second end is defined as having a length equal to one half an inside diameter of the pipe; and
wherein there is no space between the pipe coating and the pipe so that substantially all portions of an outer wall of the pipe are in contact with the pipe coating.

2. The noise reducing pipe system according to claim 1 wherein the pipe coating is manufactured using crosshead extrusion.

3. The noise reducing pipe system according to claim 1 wherein the pipe coating is at least one of mass loaded vinyl material and fire rated mas loaded vinyl material.

4. The noise reducing pipe system according to claim 1 wherein the pipe coating has a thickness ranging between 1/16 inch thick and ¼ inch thick.

5. The noise reducing pipe system according to claim 1 wherein the pipe has an inside diameter ranging between 1 inch to 18 inches.

6. The noise reducing pipe system according to claim 1 wherein the pipe is at least one of PVC and ABS pipe.

7. The noise reducing pipe system according to claim 1 wherein the thickness of the pipe coating is 25% as thick as a wall of the pipe.

8. The noise reducing pipe system according to claim 1 wherein the thickness of the pipe coating is between 50% and 75% as thick as a wall of the pipe.

9. The noise reducing pipe system according to claim 1 wherein the thickness of the pipe coating is substantially similar to the thickness of the wall of the pipe.

10. The noise reducing pipe system according to claim 1 further comprising an adhesive positioned between the pipe coating and the pipe.

11. The noise reducing pipe system according to claim 1 further comprising at least one pipe fitting adapted to be connected to at least one of the first and second ends of the pipe; wherein the at least one pipe fitting is at least one of ABS and PVC pipe fittings; and further comprising at least one respective pipe fitting coating that is connected to the respective at least one pipe fitting and extends continuously around the circumference of the pipe fitting and extends substantially the length of the pipe fitting.

12. The noise reducing pipe system according to claim 11 wherein between ¼ inch and 3 inches of an end of the pipe fitting is left exposed when the pipe fitting coating is affixed to the pipe fitting.

13. The noise reducing pipe system according to claim 1 wherein the pipe coating is a pipe sleeve having an internal diameter larger than a diameter of an outer surface of the pipe; wherein the pipe sleeve has a longitudinally extending opening that extends the entire length thereof; wherein the pipe sleeve engages the pipe to surround substantially the entire circumference of the pipe; and wherein, when connected to the pipe, the outer circumference of the pipe is in continuous contact with the inner circumference of the pipe sleeve.

14. A noise reducing pipe system comprising:
a pipe having a first end and a second end;
a pipe coating connected to the pipe and extending continuously around the circumference of the pipe and extending substantially the length of the pipe;
an adhesive positioned between the pipe coating and the pipe;
wherein the first end and the second end of the pipe have an exposed portion that does not have the pipe coating connected thereto;
wherein the exposed portion on each of the first end and the second end is between ¼ inch to 3 inches in length;
wherein there is no space between the pipe coating and the pipe so that substantially all portions of an outer wall of the pipe are in contact with the pipe coating;
wherein the thickness of the pipe coating is between 25% as thick as a wall of the pipe and as thick as the wall of the pipe;
wherein the pipe coating is manufactured using crosshead extrusion;
wherein the pipe coating is at least one of mass loaded vinyl material and fire rated mas loaded vinyl material;
wherein the pipe coating has a thickness ranging between 1/16 inch thick and ¼ inch thick.

15. The noise reducing pipe system according to claim 14 further comprising at least one pipe fitting adapted to be connected to at least one of the first and second ends of the pipe; wherein the at least one pipe fitting is at least one of ABS and PVC pipe fittings; and further comprising at least one respective pipe fitting coating that is connected to the respective at least one pipe fitting and extends continuously around the circumference of the pipe fitting and extends substantially the length of the pipe fitting.

16. The noise reducing pipe system according to claim 15 wherein end portions of the pipe fitting has an exposed portion not covered by the at least one respective pipe fitting coating; and wherein the exposed portion has a length equal to one half an inside diameter of the pipe.

17. The noise reducing pipe system according to claim 14 wherein the pipe coating is a pipe sleeve having an internal diameter larger than a diameter of an outer surface of the pipe; wherein the pipe sleeve has a longitudinally extending opening that extends the entire length thereof; wherein the pipe sleeve engages the pipe to surround substantially the entire circumference of the pipe; and wherein, when connected to the pipe, the outer circumference of the pipe is in continuous contact with the inner circumference of the pipe sleeve.

18. A noise reducing pipe system comprising:
a pipe having a first end and a second end;
a pipe coating connected to the pipe and extending continuously around the circumference of the pipe and extending substantially the length of the pipe;
at least one pipe fitting adapted to be connected to at least one of he first and second ends of the pipe;
at least one respective pipe fitting coating that is connected to the respective at least one pipe fitting and extends continuously around the circumference of the pipe fitting and extends substantially the length of the pipe fitting;
wherein the first end and the second end of the pipe have an exposed portion that does not have the pipe coating connected thereto;
wherein the exposed portion on each of the first end and the second end is defined as a length equal to one half an inside diameter of the pipe; and
wherein there is no space between the pipe coating and the pipe so that substantially all portions of an outer wall of the pipe are in contact with the pipe coating;
wherein the pipe coating is a pipe sleeve having an internal diameter larger than a diameter of an outer surface of the pipe;
wherein the pipe sleeve has a longitudinally extending opening that extends the entire length thereof;
wherein the pipe sleeve engages the pipe to surround substantially the entire circumference of the pipe;
wherein, when connected to the pipe, the outer circumference of the pipe is in continuous contact with the inner circumference of the pipe sleeve;
wherein the pipe sleeve has a thickness ranging between 1/16 inch thick and ¼ inch thick.

19. The noise reducing pipe system according to claim 11 wherein between ¼ inch and 3 inches of an end of the pipe fitting is left exposed when the pipe fitting coating is affixed to the pipe fitting.
